(19) United States
(12) Patent Application Publication
(10) Pub. No.: US 2021/0039677 A1
(43) Pub. Date: Feb. 11, 2021

(54) VEHICLE TRAVEL SYSTEM

(71) Applicant: TOYOTA JIDOSHA KABUSHIKI KAISHA, Toyota-shi (JP)

(72) Inventors: Kohta TARAO, Nagoya-shi (JP); Hiroki AWANO, Tokyo-to (JP); Kuniaki JINNAI, Nagoya-shi (JP); Yoshihiro MAEKAWA, Toyota-shi (JP)

(73) Assignee: TOYOTA JIDOSHA KABUSHIKI KAISHA, Toyota-shi (JP)

(21) Appl. No.: 16/901,084

(22) Filed: Jun. 15, 2020

(30) Foreign Application Priority Data
Aug. 6, 2019 (JP) 2019-144308

(51) Int. Cl. B60W 60/00; G05D 1/00; B60W 40/08; B60W 50/14

(52) U.S. Cl. CPC B60W 60/0051; G05D 1/0011; B60W 60/0059; B60W 60/0016; B60W 50/14; B60W 2420/42; B60W 2540/30; B60W 40/08

(57) ABSTRACT

A vehicle travel system includes a determination unit that inputs image information that has been acquired during a current trip of a vehicle, and that shows at least a peripheral situation currently around the vehicle, and inputs driving information that shows the state of the current manual driving into a learned model that has been created using image information that has been collected in a specific situation during manual driving for a driver who is manually driving a vehicle, and that shows at least a peripheral situation around the vehicle, and also using driving information that shows the state of the manual driving, and then determines whether the current situation corresponds to the specific situation, and a switching unit that, when it is determined by the determination unit that the current situation corresponds to the specific situation, is able to switch the manual driving to the remote driving.

### CROSS-REFERENCE TO RELATED APPLICATION

This application is based on and claims priority under 35 USC 119 from Japanese Patent Application No. 2019-144308 filed on Aug. 6, 2019, the disclosure of which is incorporated by reference herein.

### BACKGROUND

### Technical Field

The present disclosure relates to a vehicle travel system.

### Related Art

Technology relating to a vehicle that is able to be switched between manual driving in which the vehicle is made to travel via a driving operation performed by a vehicle occupant (hereinafter, referred to as a ‘driver’) and self-driving in which the vehicle is made to travel autonomously is disclosed in International Patent Publication No. WO 2017/203694 (Patent Document 1).

In this prior technology, driving characteristics of a driver who is performing manual driving during the vehicle's current trip are compared with reference driving characteristics that have been stored in advance. If a predetermined level of deviation occurs between the driving characteristics of the driver who is performing manual driving during the current trip and the reference driving characteristics, then the driving characteristics to be applied for the self-driving are set in accordance with the driving characteristics of the driver who is performing manual driving during the vehicle's current trip (for example, if the driver is in a hurry or the like).

In other words, in the aforementioned prior technology, because the self-driving is controlled so as to correspond to the driving characteristics of the driver who is performing manual driving during the vehicle's current trip, the driving characteristics of the driver continue unchanged even when the driving mode switches from manual driving to self-driving.

### SUMMARY

On the other hand, when considering vehicles that are capable of being operated by an operator performing a remote-control operation (i.e., are capable of being driven remotely), when the driving mode is switched, instead of being switched from manual driving to self-driving, it is switched from manual driving to remote driving, however, unlike self-driving, because remote driving operations are performed by a human operator, it is necessary for an operator to remain constantly on stand-by when a vehicle is traveling.

The present disclosure was conceived in view of the above-described circumstances, and it is an object thereof to provide a vehicle travel system that enables the burden on an operator to be lightened.

A vehicle travel system according to a first aspect includes a determination unit that inputs image information that has been acquired during a current trip of a vehicle, and that shows at least a peripheral situation currently around the vehicle, and inputs driving information that shows the current state of the manual driving into a learned model that has been created using image information that has been collected in a specific situation during manual driving for a driver who is manually driving a vehicle that is capable of being switched between manual driving and remote driving, and that shows at least a peripheral situation around the vehicle, and also using driving information that shows the state of the manual driving, the determination unit then determining whether or not the current situation corresponds to the specific situation, and also includes a switching unit that, when it is determined by the determination unit that the current situation corresponds to the specific situation, is able to switch the manual driving to the remote driving.

In the vehicle travel system of the first aspect, there are provided a determination unit which makes determinations using a learned model, and a switching unit.

The learned model is created using image information (image information A) that has been collected in a specific situation during manual driving and that shows at least a peripheral situation around the vehicle, and also using driving information (driving information A) that shows the state of the manual driving for a driver who is manually driving a vehicle which is capable of being switched between manual driving and remote driving.

In the determination unit, image information (image information B) that has been acquired during the current trip of a vehicle and that shows at least a peripheral situation currently existing around the vehicle, and driving information (driving information B) that shows the current state of the manual driving are input into the relevant learned model, and a determination is made as to whether or not the current situation corresponds to the specific situation. If it is determined by the determination unit that the current situation corresponds to the specific situation, the switching unit is able to switch the driving mode from manual driving to remote driving.

As is described above, in the present disclosure, when it is determined by the determination unit that the current situation corresponds to the specific situation, the vehicle is able to be switched from manual driving performed by a driver to remote driving performed by an operator. As a result, in the present disclosure, the driver is able to avoid manual driving in a specific situation. To put this another way, because a driver is able to perform manual driving in all situations other than a specific situation, it is no longer necessary for an operator to constantly perform remote driving, so that the load on the operator can be lightened.

Here, the term ‘specific situation’ refers to a situation in which a driver lacks confidence, such as a situation in which a driver is driving manually in a location where they lack confidence, or is driving manually in conditions in which they lack confidence. For example, ‘a location where a driver lacks confidence’ might be a merging interchange on an expressway, a small-sized carpark, a location where a driver has no previous driving experience, or a narrow, winding road or the like. ‘Conditions in which a driver lacks confidence’ might be not only conditions in which a driver lacks the confidence to drive safely such as conditions in which an oncoming car is approaching too closely, or rainy conditions or the like, but also conditions in which a driver may feel anxiety about driving such as if a driver has only just obtained their license, or must drive an unfamiliar class of vehicle or the like.

The term ‘peripheral situation around a vehicle’ is not limited, for example, to the road width, other vehicles around the host vehicle, the weather, light conditions, and pedestrians and the like, but refers to all obstacles and the like.

The term ‘driving information’ refers, for example, to behavior information for a vehicle being driven manually by a driver, or bioinformation for the driver, and whether or not a driver is in a state of anxiety is determined using these types of information. In other words, if a driver is estimated to be in a state of anxiety, then the driver is estimated to be in the aforementioned specific situation.

A vehicle travel system of a second aspect is characterized in that, in the vehicle travel system of the first aspect, the driving information showing the state of the manual driving includes behavior information detected by behavior sensors that detect behavior of the vehicle.

In the vehicle travel system of the second aspect, the driving information showing the state of the manual driving includes behavior information detected by behavior sensors that detect the behavior of the vehicle, and a ‘specific situation’ can be detected from the vehicle behavior information.

Here, the ‘vehicle behavior information’ includes information such as, for example, the vehicle speed, acceleration, angular velocity, and steering angle and the like. When the vehicle behavior is unstable such as the brake being applied overly frequently, then the driver is estimated to be in a state of anxiety.

A vehicle travel system of a third aspect is characterized in that, in the vehicle travel system of the first or second aspects, the driving information showing the state of the manual driving includes bioinformation detected by biosensors that detect a biological state of the driver.

In the vehicle travel system of the third aspect, the driving information showing the state of the manual driving includes bioinformation detected by biosensors that detect a biological state of the driver, and a ‘specific situation’ can be detected from the driver's bioinformation.

Here, the ‘driver's bioinformation’ includes bioinformation such as, for example, the driver's pulse, brain waves, blood pressure, and heart rate. When numerical values in the driver's bioinformation are unstable such as when the driver's pulse increases and the like, then the driver is estimated to be in a state of anxiety.

A vehicle travel system of a fourth aspect is characterized in that, in the vehicle travel system of any one of the first through third aspects, there is further provided a notification unit that, when the driving mode is switched from manual driving to remote driving by the switching unit, transmits a switching notification to the operator who will perform the remote driving to switch from the manual driving to the remote driving.

In the vehicle travel system of the fourth aspect, a notification unit is additionally provided. When the driving mode is switched from manual driving to remote driving by the switching unit, a switching notification is transmitted by the notification unit to the operator who will perform the remote driving announcing the switch from the manual driving to remote driving.

As has been described above, the vehicle travel system of the first aspect provides the excellent effect that the burden on an operator can be lightened.

The vehicle travel system of the second aspect provides the excellent effect that a driver can be estimated to be in a specific situation from vehicle behavior information.

The vehicle travel system of the third aspect provides the excellent effect that a driver can be estimated to be in a specific situation from the driver's bioinformation.

The vehicle travel system of the fourth aspect provides the excellent effect that an operator can be made aware in advance that the driving mode is about to be switched from manual driving to remote driving.

### BRIEF DESCRIPTION OF THE DRAWINGS

Preferred embodiments of the present disclosure will be described in detail based on the following figures, wherein:

FIG. 1 is a structural view showing the schematic structure of a vehicle travel system according to the present exemplary embodiment;

FIG. 2 is a block diagram showing a hardware structure of a vehicle used in the vehicle travel system according to the present exemplary embodiment;

FIG. 3 is a block diagram illustrating an action of a vehicle control device of the vehicle used in the vehicle travel system according to the present exemplary embodiment;

FIG. 4 is a block diagram illustrating an action of the vehicle control device of the vehicle used in the vehicle travel system according to the present exemplary embodiment;

FIG. 5 is a block diagram showing a function structure of the vehicle control device of the vehicle used in the vehicle travel system according to the present exemplary embodiment.

FIG. 6 is a block diagram showing a hardware structure of a remote-control operating device used in the vehicle travel system according to the present exemplary embodiment;

FIG. 7 is a block diagram showing a function structure of a remote-control controller device used in the vehicle travel system according to the present exemplary embodiment;

FIG. 8 is a block diagram showing a hardware structure of an information server used in the vehicle travel system according to the present exemplary embodiment;

FIG. 9 is a block diagram showing an example of a function structure of the information server used in the vehicle travel system according to the present exemplary embodiment; and

FIG. 10 is a flowchart illustrating a flow of processing performed in order to switch from manual driving to remote driving in accordance with driver information in the vehicle travel system according to the present exemplary embodiment.

### DETAILED DESCRIPTION

### Outline

Firstly, an outline of a vehicle travel system according to the present exemplary embodiment will be described.

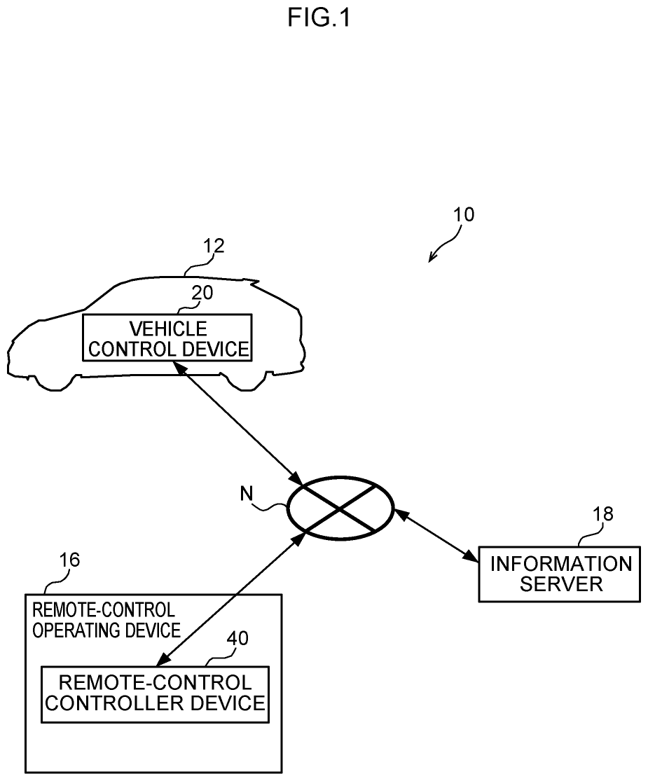

A structural view showing the schematic structure of a vehicle travel system 10 according to the present exemplary embodiment is shown in FIG. 1. As is shown in FIG. 1, the vehicle travel system 10 according to the present exemplary embodiment is formed so as to include a vehicle (i.e., an automobile) 12 that is capable of being both manually driven and remotely driven, a remote-control operating device 16 that drives the vehicle 12 remotely, and an information server 18.

The vehicle 12 in the present exemplary embodiment is provided with a vehicle control device 20, and the remote-control operating device 16 is provided with a remote-control controller device 40. In the vehicle travel system 10, the vehicle control device 20 of the vehicle 12, the remote-control controller device 40 of the remote-control operating device 16, and the information server 18 are mutually connected together via a network N.

Note that the vehicle travel system 10 shown in FIG. 1 is formed by a single vehicle 12, a single remote-control operating device 16, and a single information server 18, however, the numbers thereof are not limited to these. Because of this, the vehicle travel system 10 may also be formed so as to include two or more vehicles 12, and so as to include two or more of each of the remote-control operating devices 16 and the information servers 18.

Moreover, in the present exemplary embodiment, the vehicle 12 is able to be driven manually based on operations performed by a driver, and is also able to be driven remotely based on operations performed by a remote driver (i.e., an operator) on the remote-control operating device 16, however, the vehicle 12 may instead be set up so that it is able to perform self-driving instead of being driven remotely.

### Vehicle

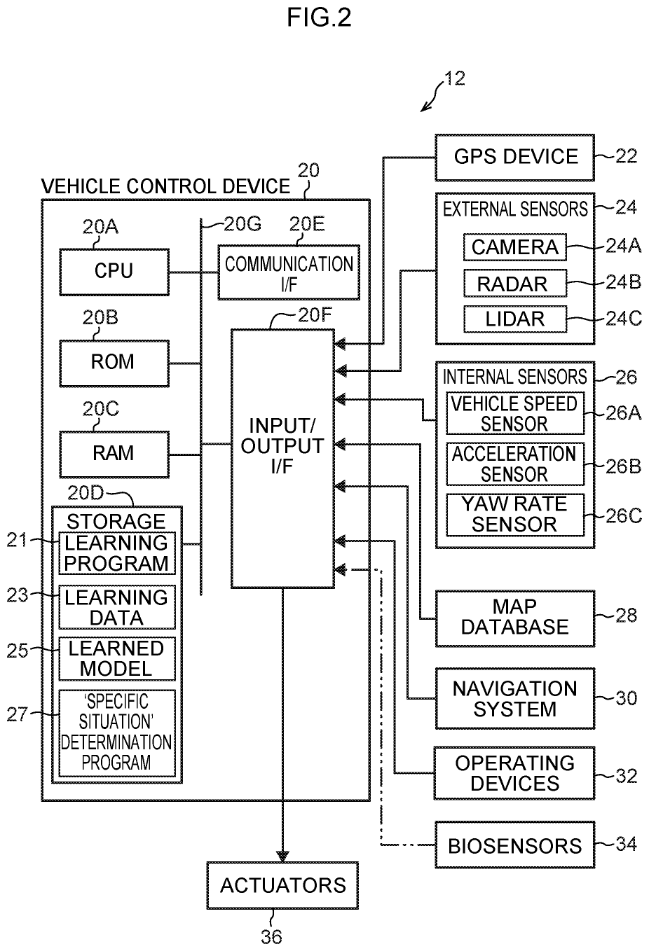

A block diagram showing a hardware structure of devices mounted in the vehicle 12 used in the vehicle travel system according to a form of the present exemplary embodiment is shown in FIG. 2.

As is shown in FIG. 2, in addition to the above-described vehicle control device 20, the vehicle 12 is provided with a GPS (Global Positioning System) device 22, external sensors 24, internal sensors 26, a map database 28, a navigation system 30, operating devices 32, biosensors 34, and actuators 36.

The vehicle control device 20 is formed so as to include a CPU (Central Processing Unit) 20A, ROM (Read Only Memory) 20B, RAM (Random Access memory) 20C, storage 20D, a communication I/F (Interface) 20E, and an input/output I/F 20F. The CPU 20A, the

ROM 20B, the RAM 20C, the storage 20D, the communication I/F 20E, and the input/output I/F 20F are mutually connected so as to be able to communicate with each other via a bus 20G.

Here, the CPU 20A executes various types of programs, and controls the respective units. In other words, the CPU 20A reads a program from the ROM 20B, and executes this program using the RAM 20C as a workspace. In the present exemplary embodiment, execution programs are stored in the ROM 20B.

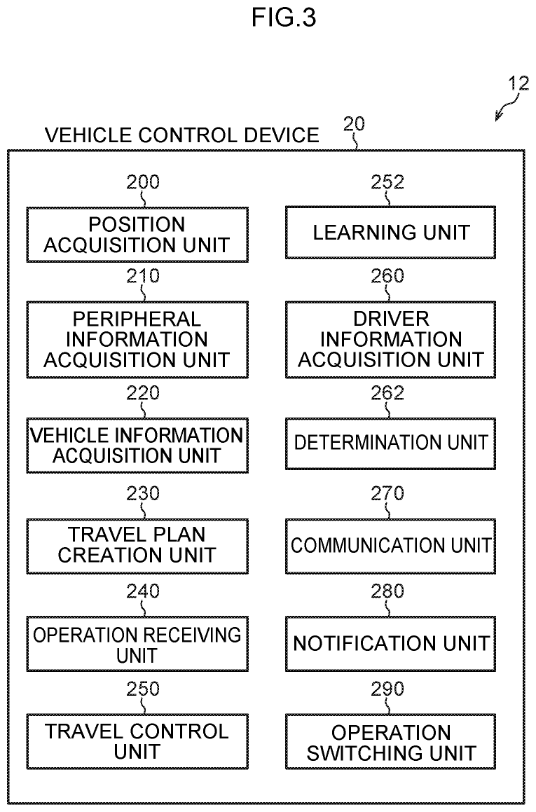

As a result of the CPU 20A executing execution programs, the vehicle control device 20 is able to function as a position acquisition unit 200, a peripheral information acquisition unit 210, a vehicle information acquisition unit 220, a travel plan creation unit 230, an operation receiving unit 240, a travel control unit 250, a learning unit 252, a driver information acquisition unit 260, a determination unit 262, a communication unit 270, a notification unit 280, and an operation switching unit 290 which are shown in FIG. 3 and are each described below. Note that a block diagram showing an example of a function structure of the vehicle control device 20 in the vehicle 12 used in the vehicle travel system 10 according to the present exemplary embodiment is shown in FIG. 3.

As is described above, the ROM 20B shown in FIG. 2 stores various types of programs and various types of data. In contrast, the RAM 20C temporarily stores programs and data and serves as a workspace.

The storage 20D is formed by an HDD (Hard Disk Drive) or an SSD (Solid State Drive), and an operating system that includes a learning program 21 and a ‘specific situation’ determination program 27 which determines a specific situation are stored in the storage 20D.

In this case, the CPU 20A reads the learning program 21 from the storage 20D and expands the learning program 21 in the RAM 20C. The CPU 20A then executes the expanded learning program 21. In addition, the CPU 20A reads the ‘specific situation’ determination program 27 from the storage 20D and expands the ‘specific situation’ determination program 27 in the RAM 20C. The CPU 20A then executes the expanded ‘specific situation’ determination program 27. Furthermore, learning data 23 and a learned model 25 are also stored in the storage 20D.

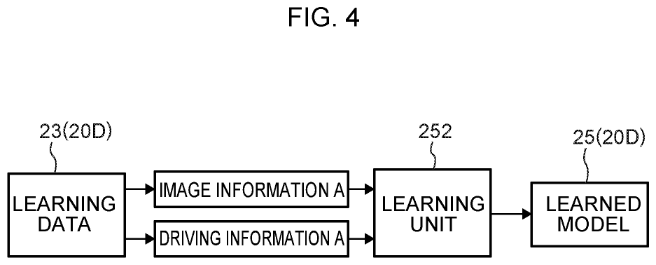

Here, as is shown in FIG. 4, image information A showing the peripheral situation around the vehicle 12 and driving information A which includes data relating to the behavior of the vehicle 12 that have been collected in a specific situation during manual driving are stored in the learning data 23. Note that the learned model 25 is described below.

In addition, the ‘specific situation’ refers, for example, to a situation in which a driver is driving manually in a location where they lack confidence, or is driving manually in conditions in which they lack confidence. For example, ‘a location where a driver lacks confidence’ might be a merging interchange on an expressway, a small-sized carpark, a location where a driver has no previous driving experience, or a narrow, winding road or the like. ‘Conditions in which a driver lacks confidence’ might be not only conditions in which a driver lacks the confidence to drive safely such as conditions in which an oncoming car is approaching too closely, or rainy conditions or the like, but also conditions in which a driver may feel anxiety about driving such as if a driver has only just obtained their license, or must drive an unfamiliar class of vehicle or the like. Because of this, the ‘specific situation’ refers to behavior which is different from normal driving behavior such as, for example, when the vehicle is traveling at too slow a speed, or when the brakes are being applied overly frequently, or the like.

The communication I/F 20E is formed so as to include an interface that is used for connecting to the network N in order to communicate with the remote-control controller devices 40, and the information server 18 and the like shown in FIG. 1. A communication Standard such as, for example, LTE or Wi-Fi (Registered Trademark) or the like is utilized for this interface.

Note that the communication I/F 20E shown in FIG. 2 may utilize DSRC (Dedicated Short Range Communication) or the like. The communication I/F 20E of the present exemplary embodiment transmits acquisition images acquired by a camera to the external remote-control operating device 16 of a vehicle 12 via the network N (see FIG. 1), and receives from the remote-control operating device 16 remote-control operation information, which is operation information that is used to operate the vehicle 12.

The input/output I/F 20F is formed so as to include an interface that is used in order to perform communication between the respective devices mounted in the vehicle 12. The vehicle control device 20 of the present exemplary embodiment is connected via the input/output I/F 20F to the GPS device 22, the external sensors 24, the internal sensors 26, the map database 28, the navigation system 30, the operating devices 32, the biosensors 34, and the actuators 36.

Note that the GPS device 22, the external sensors 24, the internal sensors 26, the map database 28, the navigation system 30, the operating devices 32, the biosensors 34, and the actuators 36 may also be directly connected to the bus 20G. Additionally, they may also be connected together via a CAN (Control Area Network), or may be connected together via various types of ECU or a gateway ECU.

The GPS device 22 is a device that measures a current position of the vehicle 12, and is formed so as to include an antenna (not shown in the drawings) that receives signals from GPS satellites. More specifically, the GPS device 22 measures the position (for example, the vehicle latitude and longitude) of the vehicle 12 by receiving signals from three or more GPS satellites, and transmits the measured position information for the vehicle 12 to devices that are connected to the input/output I/F 20F. Note that it is also possible to employ some other means that is capable of specifying the longitude and latitude of the vehicle 12 instead of the GPS device 22.

The external sensors 24 are a group of sensors that detect peripheral information around the vehicle 12. The external sensors 24 are formed so as to include at least one of a camera 24A that acquires images within a predetermined range, a radar 24B that transmits probe waves within a predetermined range, and a LIDAR (Laser Imaging Detecting And Ranging) 24C that scans a predetermined range.

The camera 24A (not shown in the drawings) is provided, for example, inside the vehicle cabin in an upper portion of the windshield glass of the vehicle 12, and acquires the image information B by photographing the situation outside the vehicle 12. In the present exemplary embodiment, image information B showing the current peripheral situation around the vehicle 12 is acquired by the camera 24A. The current image information B acquired by the camera 24A is transmitted to the input/output I/F 20F, and is then transmitted to the devices connected to the input/output I/F 20F via the input/output I/F 20F. Note that a monocular camera or stereo cameras may be used for the camera 24A. In the case of stereo cameras, two image acquisition units are disposed so as to be able to reproduce binocular parallax. Depth direction information is included in the image information B acquired from stereo cameras.

The radar 24B measures distances to obstacles by transmitting radio waves (for example, milliwaves) around the periphery of the vehicle 12, and then receiving radio waves reflected back by the obstacles. Obstacle information detected by the radar 24B is transmitted to the input/output I/F 20F, and is then transmitted to the devices connected to the input/output I/F 20F via the input/output I/F 20F.

The LIDAR 24C detects obstacles by transmitting light around the periphery of the vehicle 12, and then receiving light reflected back by the obstacles and measuring the distance to the reflection point. Obstacle information detected by the LIDAR 24C is transmitted to the input/output I/F 20, and is then transmitted to the devices connected to the input/output I/F 20F via the input/output I/F 20F. Note that it is not necessary for the camera 24A, the radar 24B, and the LIDAR 24C to be provided in combination with each other.

The internal sensors (i.e., behavior sensors) 26 are sensors that detect the behavior of the vehicle 12 such as the traveling state and the like of the vehicle 12 by detecting various physical quantities while the vehicle 12 is traveling. The internal sensors 26 include, for example, at least one of a vehicle speed sensor 26A, an acceleration sensor 26B, and a yaw rate sensor 26C. In the present exemplary embodiment, current behavior information (i.e., the driving information B) for the vehicle 12 being driven manually by a driver is acquired by the internal sensors 26. Note that the term ‘vehicle behavior information’ includes information such as, for example, the vehicle speed, acceleration, angular velocity, and steering angle and the like of the vehicle 12.

The vehicle speed sensor 26A is provided, for example on a vehicle wheel, or on a hub and rotor, or driveshaft or the like that rotates integrally with a vehicle wheel, and detects the vehicle speed by detecting the rotation speed of the vehicle wheel. Vehicle speed information (i.e., vehicle wheel speed information) detected by the vehicle speed sensor is transmitted to the input/output I/F 20F, and is then transmitted to the devices connected to the input/output I/F 20F via the input/output I/F 20F.

The acceleration sensor 26B detects vehicle acceleration generated by an acceleration, or by a turn, or by a collision or the like of the vehicle. The acceleration sensor includes, for example, a front-rear acceleration sensor that detects acceleration in the front-rear direction of the vehicle, a lateral acceleration sensor that detects lateral acceleration in the left-right direction (i.e., in the vehicle width direction) of the vehicle, and an up-down acceleration sensor that detects acceleration in the up-down direction of the vehicle. Acceleration information for the vehicle is transmitted to the input/output I/F 20F, and is then transmitted to the devices connected to the input/output I/F 20F via the input/output I/F 20F.

The yaw rate sensor 26C detects a yaw rate (i.e., a rotational angular velocity) around a vertical axis at the center of gravity of the vehicle. For example, a gyro sensor can be used as the yaw rate sensor. Yaw rate information detected by the yaw rate sensor is transmitted to the input/output I/F 20F, and is then transmitted to the devices connected to the input/output I/F 20F via the input/output I/F 20F.

Note that in addition to these sensors, although not shown in the drawings, it is also possible to detect a steering angle of a steering wheel using a steering angle sensor, and an operational amount of an accelerator pedal and an operational amount of the brake pedal by means of operational amount sensors.

Behavior information for the vehicle 12 is acquired by the above-described internal sensors 26, and this behavior information makes it possible to determine whether the vehicle is exhibiting a different behavior pattern from a normal situation, such as if the vehicle 12 were travelling at a low speed, or such as there being an increase in the number of times the brake pedal is operated, or the like. In this way, it is possible to estimate from the behavior of the vehicle 12 whether or not a driver is in a state of anxiety. In other words, if a driver is estimated to be in a state of anxiety, then that driver is estimated to be in a specific situation.

The map database 28 is provided with map information and is stored, for example, in an HDD (Hard Disc Drive) mounted in the vehicle 12. The map information includes, for example, road position information, road contour information (for example, differentiations between curves and straight-line portions, and the curvature of curves and the like), and positional information relating to intersections and road forks and the like.

Furthermore, because positional information relating to shielding structures such as buildings and walls and the like, and SLAM (Simultaneous Localization and Mapping) technology are employed, output signals from the external sensors 14 may also be included in the map information. Note that, although not shown in the drawings, it is also possible for the map database 28 to be stored in a computer in an installation such as an information processing center or the like that is able to communicate with the vehicle 12.

The navigation system 30 provides a driver of the vehicle 12 with guidance to a destination which has been set by the driver of the vehicle 12, and calculates a route to be travelled by the vehicle 12 based on positional information for the vehicle 12 which has been measured by the GPS device 22, and on the map information in the map database 28. The most appropriate vehicle lane when the vehicle 12 is travelling along a multi-lane road may also be included in this route information.

In addition, the navigation system 30, for example, also calculates a target route from the current position of the vehicle 12 to a target destination, and notifies a vehicle occupant about this target route via a display on a display unit or via a voice output through speakers. The target route information for the vehicle 12 created by the navigation system 30 is transmitted to the input/output I/F 20F, and is then transmitted to the devices connected to the input/output I/F 20F via the input/output I/F 20F.

The operating devices 32 are a group of switches that are operated by a driver driving the vehicle 12. The operating devices 32 are formed so as to include a steering wheel which serves as switch enabling a steering wheel of the vehicle 12 to be steered, an accelerator pedal which serves as a switch for causing the vehicle 12 to accelerate, and a brake pedal which serves as a switch for causing the vehicle 12 to decelerate. Travel information generated by the operating devices 32 is transmitted to the input/output I/F 20F, and is then transmitted to the devices connected to the input/output I/F 20F via the input/output I/F 20F.

Note that, in the present exemplary embodiment, it is also possible for biosensors 34 to be provided. The biosensors 34 are sensors that are capable of acquiring current bioinformation (i.e., driving information B) about a driver. Examples of this ‘driver bioinformation’ include, for example, the driver's pulse, brain waves, blood pressure, and heart rate and the like. In this case, bioinformation obtained by the biosensors 34 is transmitted to the input/output I/F 20F, and is then transmitted to the devices connected to the input/output I/F 20F via the input/output I/F 20F. It is possible to estimate from the bioinformation of the driver whether or not the driver is in a state of anxiety. As is described above, by estimating whether a driver is in a state of anxiety, it is possible to estimate whether the driver is in a specific situation.

Moreover, in addition to these, although not shown in the drawings, it is also possible to set up technology that enables image information such as the current facial expression and the like of the driver (i.e., the driving information B) to be acquired using an in-cabin camera.

In this case, the image information obtained from the in-cabin camera is transmitted to the input/output I/F 20F, and is then transmitted to the devices connected to the input/output I/F 20F via the input/output I/F 20F. It is possible to estimate from the image information of the driver whether or not the driver is in a state of anxiety.

The actuators 36 are formed so as to include a steering actuator that serves as a steering mechanism, an accelerator actuator, and a brake actuator. The steering actuator controls the steering of the front wheels of the vehicle 12. The accelerator actuator controls the acceleration of the vehicle 12 by controlling the travel motor. The brake actuator controls the deceleration of the vehicle 12 by controlling the brakes thereof.

As is described above, the vehicle control device 20 shown in FIG. 3 has the position acquisition unit 200, the peripheral information acquisition unit 210, the vehicle information acquisition unit 220, the travel plan creation unit 230, the operation receiving unit 240, the travel control unit 250, the learning unit 252, the driver information acquisition unit 260, the determination unit 262, the communication unit 270, the notification unit 280, and the operation switching unit (i.e., the switching unit) 290. The functions of each structure are realized as a result of the CPU 20A shown in FIG. 2 reading and executing an execution program stored in the ROM 20B.

The position acquisition unit 200 shown in FIG. 3 has a function of acquiring the current position of the vehicle 12. The position acquisition unit 200 acquires position information for the vehicle 12 from the GPS device 22 (see FIG. 2) via the input/output I/F 20F (see FIG. 2).

The peripheral information acquisition unit 210 has a function of acquiring current peripheral information (i.e., the image information B) for the area around the vehicle 12. The peripheral information acquisition unit 210 acquires the peripheral information for the vehicle 12 from the external sensors 24 (see FIG. 2) via the input/output I/F 20F. This peripheral information is not limited to information about other vehicles peripheral to the vehicle 12, or the weather, brightness, travel course width, and pedestrians and the like, and includes information about other obstacles.

The vehicle information acquisition unit 220 has a function of acquiring current behavior information (i.e., the driving information B) for the vehicle 12. The vehicle information acquisition unit 220 acquires the behavior information for the vehicle 12 from the internal sensors 26 (see FIG. 2) via the input/output I/F 20F. This ‘behavior information’ includes the vehicle speed, acceleration, and steering angle and the like of the vehicle 12.

The travel plan creation unit 230 has a function of creating a travel plan that is used to enable the navigation system 30 (see FIG. 2) to cause the vehicle 12 to travel via the input/output I/F 20F based on the position information acquired by the position acquisition unit 200, the peripheral information (i.e., the image information B) acquired by the peripheral information acquisition unit 210, and the behavior information (i.e., the driving information B) acquired by the vehicle information acquisition unit 220. The travel plan is formed not only by a preset travel route to a destination, but shows a course that avoids obstacles in front of the vehicle 12, and also includes information about the speed and the like of the vehicle 12.

When manual driving is being performed based on operations performed by the driver of the vehicle 12, the operation receiving unit 240 has a function of receiving signals output from the operating devices 32 (see FIG. 2) via the input/output I/F 20F. The operation receiving unit 240 creates vehicle operation information which is operation information that is used to control the actuators 36 (see FIG. 2) via the input/output I/F 20F based on the signals received from the operating devices 32.

The travel control unit 250 has functions of controlling manual driving based on the vehicle operation information received from the operation receiving unit 240, and controlling remote driving based on the remote-control operation information received from the remote-control operating devices 16.

The learning unit 252 is realized as a result of the CPU 20A shown in FIG. 2 reading the learning program 21 from the storage 20D and then executing this learning program 21. More specifically, as is shown in FIG. 4, the learning unit 252 has a function of creating a learned model 25 which is associated with a ‘specific situation’ by mechanically learning image information A showing the peripheral situation around the vehicle 12 which has been collected in a specific situation and has been acquired from the learning data 23 stored in the storage 20D, and also mechanically learning the driving information A for the vehicle 12 as learning data.

Note that, for example, a deep neural network can be used for the learned model 25. In addition, for example, a back-propagation method is used to create the learned model 25. For example, the learned model 25 is created by causing a deep neural network to mechanically learn to output information showing that a specific situation exists when the image information A and the driving information A are input. The probability that a specific situation exists is used as this output.

The driver information acquisition unit 260 acquires a driver's ID. Note that the driver ID is information specifying a particular driver, and the above-described learned model 25 is created for each individual driver ID.

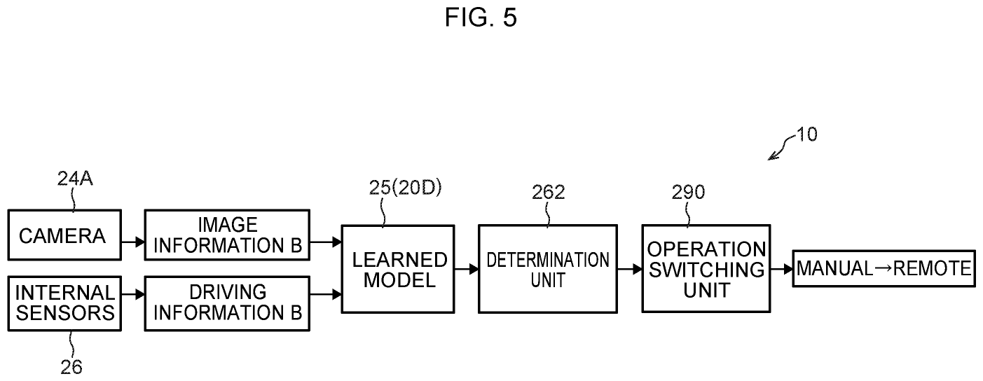

The determination unit 262 is realized as a result of the CPU 20A shown in FIG. 2 reading the ‘specific situation’ determination program 27 stored in the storage 20D and then executing this ‘specific situation’ determination program 27. More specifically, as is shown in FIG. 5, the determination unit 262 has a function of determining whether or not the current situation is a ‘specific situation’ from the current image information B and the current driving information B acquired during the current vehicle trip and input into the learned model 25.

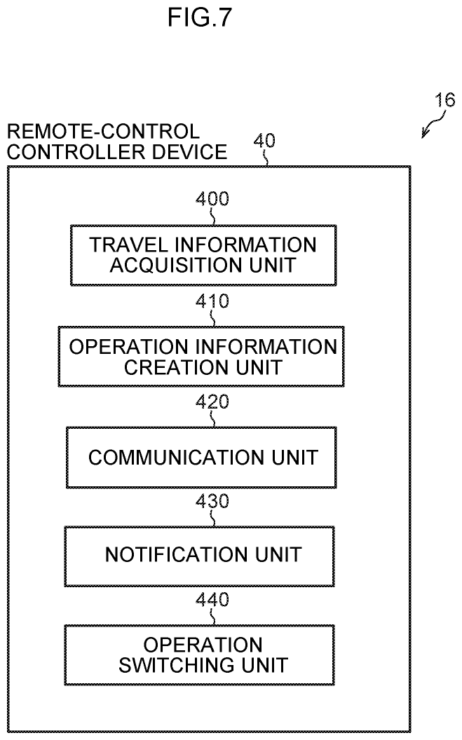

The communication unit 270 has a function of transmitting and receiving information between itself and a communication unit 420 (see FIG. 7) of the remote-control controller device 40 (described below; see FIG. 7). When the determination unit 262 has determined that a ‘specific situation’ exists, the communication unit 270 transmits the current image information B and the current driving information B to the remote-control controller device 40. Additionally, the communication unit 270 receives remote-control operation information created in an operation information creation unit 410 (described below; see FIG. 7).

The notification unit 280 has a function of transmitting a switching notification to an operator who is performing remote driving notifying them about a switch from manual driving to remote driving when the vehicle 12 is switched from manual driving to remote driving. Additionally, the notification unit 280 has a further function of receiving switching notifications transmitted from the remote-control operating devices 16 to the vehicle control device 20 notifying it about a switch from remote driving to manual driving.

The operation switching unit (i.e., switching unit) 290 has a function of transferring (i.e., switching) an operating authority, which is the authority to operate the vehicle 12 in which the vehicle control device 20 is mounted, to a remote driver who is operating the remote-control operating device 16.

Here, in the vehicle control device 20, when a driver who is driving manually operates an operating unit (not shown in the drawings), a switching signal or a switching preparation signal that implements a switch from manual driving to remote driving is output to the remote-control operating device 16. As a result, the operating authority of that vehicle control device 20 can be switched to the remote-control operating device 16.

In this way, when operating authority is transferred to a remote driver, the vehicle control device 20 transmits an operating authority command to the remote-control operating device 16 operated by that particular remote driver. This transmitting of the operating authority command may be performed at the same time as the switching notification is sent to the remote-control operating device 16, or after this switching notification has been sent.

As a result of the operating authority being transferred from the vehicle 12 to a remote driver, the travel control device 250 causes the vehicle 12 to travel based on the remote-control operation information received from the remote-control operating device 16 in the vehicle 12. In other words, the vehicle 12 is switched from manual driving to remote driving, and remote driving is performed by the remote driver.

### Remote-Control Operating Devices

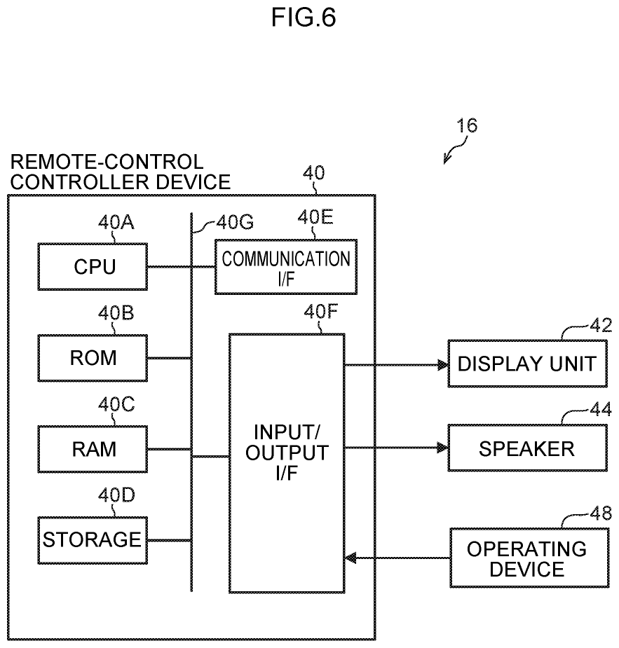

FIG. 6 is a block diagram showing a hardware structure of devices that are mounted in the remote-control operating devices 16 of the present exemplary embodiment.

In addition to the above-described remote-control controller device 40, the remote-control operating devices 16 include a display unit 42, a speaker 44, and operating devices 48. The remote-control controller device 40 is formed so as to include a CPU 40A, ROM 40B, RAM 40C, storage 40D, a communication I/F 40E, and an input/output I/F 40F. The CPU 40A, the ROM 40B, the RAM 40C, the storage 40D, the communication I/F 40E, and the input/output I/F 40F are mutually connected so as to be able to communicate with each other via a bus 40G.

Note that the functions of the CPU 40A, the ROM 40B, the RAM 40C, the storage 40D, the communication I/F 40E, and the input/output I/F 40F are the same as those of the CPU 20A, the ROM 20B, the RAM 20C, the storage 20D, the communication I/F 20E, and the input/output I/F 20F of the above-described vehicle control device 20 shown in FIG. 2.

The CPU 40A show in FIG. 6 reads a program from the ROM 40B, and executes this program using the RAM 40C as a workspace. In the present exemplary embodiment, processing programs are stored in the ROM 40B.

As a result of the CPU 40A executing these processing programs, the remote-control controller device 40 has a travel information acquisition unit 400, an operation information creation unit 410, a communication unit 420, a notification unit 430, and an operation switching unit (i.e., a switching unit) 440 which are shown in FIG. 7. Note that a block diagram showing an example of a function structure of the remote-control controller device 40 used in the vehicle travel system 10 according to the present exemplary embodiment is shown in FIG. 7.

As is shown in FIG. 6, the display unit 42, the speaker 44, and the operating devices 48 are connected via the input/output I/F 40F to the remote-control controller device 40 of the present exemplary embodiment. Note that the display unit 42, the speaker 44, and the operating devices 48 may also be directly connected to the bus 40G.

The display unit 42 is a liquid crystal monitor that is used to display images acquired by a camera (not shown in the drawings) of the vehicle 12 (see FIG. 2), and various types of information relating to the vehicle 12.

The speaker 44 reproduces audio recorded together with the acquisition images by a microphone (not shown in the drawings) incorporated into the camera of the vehicle 12.

The operating devices 48 are controllers that are operated by a remote driver who is able to drive via a remote-control operation utilizing the remote-control operating device 16. The operating devices 48 are formed so as to include a steering wheel which serves as switch enabling a steering wheel of the vehicle 12 to be steered, an accelerator pedal which serves as a switch for causing the vehicle 12 to accelerate, and a brake pedal which serves as a switch for causing the vehicle 12 to decelerate.

Note that the forms of each operating device 48 are not limited to these. For example, it is also possible to provide lever switches instead of a steering wheel, or to provide push button switches or lever switches instead of the pedal switches used for the accelerator pedal and brake pedal.

As has been described above, the remote-control controller device 40 shown in FIG. 7 has the travel information acquisition unit 400, the operation information creation unit 410, the communication unit 420, the notification unit 430, and the operation switching unit 440.

The travel information acquisition unit 400 has a function of acquiring acquisition images and audio from the camera that have been transmitted from the vehicle control device 20 (see FIG. 2), as well as vehicle information such as the vehicle speed and the like. The acquired acquisition images and vehicle information are displayed on the display unit 42, and the audio information is output from the speaker 44.

The operation information creation unit 410 has a function of receiving signals output from each operation device 48 when remote driving is being performed based on operations performed by a remote driver. Additionally, the operation information creation unit 410 creates remote-control operation information to be transmitted to the vehicle control device 20 based on signals received from each operation device 48.

The communication unit 420 has a function of transmitting and receiving information between itself and the communication unit 270 (see FIG. 3) on the vehicle control device 20 (see FIG. 3) side. When the determination unit 262 of the vehicle control device 20 determines that a ‘specific situation’ exists, the communication unit 420 receives from the communication unit 270 the current image information B and the current driving information B that were transmitted from the vehicle control device 20 to the remote-control controller device 40. Remote-control operation information created in the operation information creation unit 410 is then transmitted to the vehicle control device 20.

The notification unit 430 has a function of receiving a switching notification that was transmitted from the communication unit 270 (see FIG. 3) notifying about a switch from manual driving to remote driving. Additionally, the notification unit 430 has a further function of transmitting a switching notification to the vehicle control device 20 notifying about a switch from remote driving to manual driving before the transition from remote driving to manual driving is made.

The operation switching unit (switching unit) 440 has a function of causing the vehicle control device 20 to execute the switch to remote driving. In the remote-control operating device 16, when a remote driver who is to perform the remote driving operates an operating unit (not shown in the drawings), a switching signal or a switching preparation signal that causes the switch from manual driving to remote driving to be made is output to the vehicle control device 20.

For example, if information relating to the operating authority has already been received from the vehicle control device 20 (see FIG. 3) of the vehicle 12 (see FIG. 2), then as a result of the operation switching device 440 outputting a switching signal to the vehicle control device 20, it becomes possible to switch from manual driving to remote driving in the vehicle 12.

Additionally, for example, if the operation switching unit 440 firstly transmits a switching preparation signal to the vehicle control device 20, then the switch from manual driving to remote driving is made in the vehicle 12 at the stage when operating authority is granted in the operation switching unit 290 of the vehicle control device 20. Note that it is also possible for the switch from remote driving to manual driving in the vehicle 12 to be made in the operation switching unit 440.

### Information Server

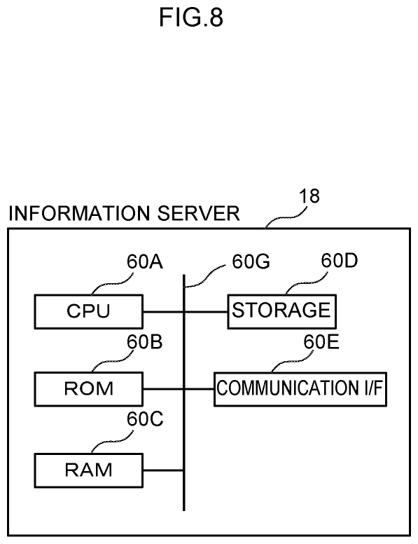

A block diagram showing a hardware structure of the information server 18 used in the vehicle travel system according to the present exemplary embodiment is shown in FIG. 8.

As is shown in FIG. 8, the information server 18 is formed so as to include a CPU 60A, ROM 60B, RAM 60C, storage 60D, and a communication I/F 60E. The CPU 60A, the ROM 60B, the RAM 60C, the storage 60D, and the communication I/F 60E are mutually connected so as to be able to communicate with each other via a bus 60G.

Note that the functions of the CPU 60A, the ROM 60B, the RAM 60C, the storage 60D, and the communication I/F 60E are substantially the same as those of the CPU 20A, the ROM 20B, the RAM 20C, the storage 20D, and the communication I/F 20E of the above-described vehicle control device 20 shown in FIG. 2.

The CPU 60A shown in FIG. 8 reads programs from the ROM 60B or from the storage 60D, and then executes these programs using the RAM 60C as a workspace.

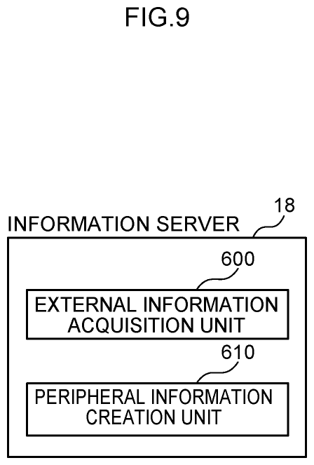

In the present exemplary embodiment, an information processing program is stored in the storage 60D. As a result of the CPU 60A executing the information processing program, an external information acquisition unit 600 and a peripheral information creation unit 610 which are shown in FIG. 9 are able to perform their functions.

FIG. 9 is a block diagram showing an example of a function structure of the information server 18. As is shown in FIG. 9, the information server 18 has the external information acquisition unit 600 and the peripheral information creation unit 610.

The external information acquisition unit 600 has a function of acquiring various types of information from outside the information server 18. In addition to weather information which serves as environmental information, earthquake information, and traffic information, this acquired information also includes news information and information acquired by sensors of other vehicles.

The peripheral information creation unit 610 has a function of creating peripheral information to transmit to the vehicle control device 20 based on the information acquired by the external information acquisition unit 600. For example, out of the information acquired by the external information acquisition unit 600, the peripheral information creation unit 610 creates information about the area around the current location of the vehicle 12 that has transmitted the environmental information as the peripheral information intended for the vehicle 12.

### Vehicle Actions and Effects

Next, actions and effects of a vehicle according to the present exemplary embodiment will be described.

In the present exemplary embodiment, as is shown in FIG. 5, the determination unit 262 which makes determinations using the learned model 25, and the switching unit 290 are provided in the vehicle travel system 10. As is shown in FIG. 4, the learned model 25 is created using the image information A which is collected in a specific situation during manual driving, and which shows at least a peripheral situation around the vehicle 12, and also using driving information A which shows the state of the manual driving for a driver who is manually driving the vehicle 12 that is capable of switching between manual driving and remote driving.

As is shown in FIG. 5, in the determination unit 252, the current image information B and the current driving information B acquired during the current vehicle trip are input into the relevant learned model 25, and whether or not the current situation corresponds to the relevant specific situation is determined.

More specifically, as a result of the determination unit 262 inputting, for example, the current image information B and the current driving information B into the learned model 25, and then determining whether or not the information output from the learned model 25 shows that a specific situation exists (for example, whether or not the probability that a specific situation exists is above a threshold value), it is possible to determine whether or not the current situation corresponds to a specific situation. If it is determined by the determination unit 262 that the current situation does correspond to a specific situation, then the switch from manual driving to remote driving can be made in the operation switching unit 290.

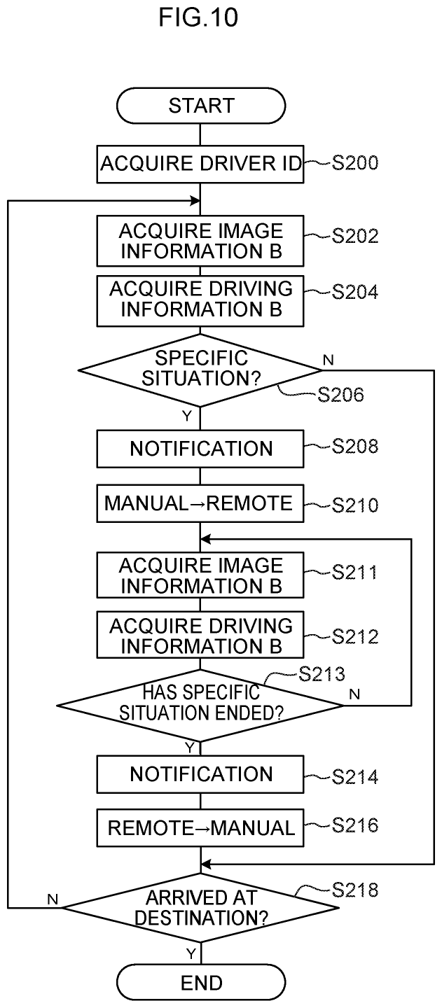

Hereinafter, an example of a flow of switching processing that is performed in the present exemplary embodiment in order to switch between the manual driving of a vehicle 12 and the remote driving thereof via a remote-control operating device 16 in accordance with driver information will be described with reference to FIG. 2 through FIG. 7 using the flowchart shown in FIG. 10.

Note that this switching processing is realized as a result of the CPU 20A reading the ‘specific situation’ determination program 27 and the like stored in the storage 20D, and then expanding this ‘specific situation’ determination program 27 in the RAM 20C.

As is shown in FIG. 10, in step S200, the CPU 20A acquires the driver's ID registered in the storage 20D.

Next, while the vehicle 12 is traveling, in step S202, the image information B obtained by photographing the external situation around the vehicle 12 is acquired and, in step S204, the current driving information B for the vehicle 12 which is being driven manually by a driver is acquired. Note that the processing of step S202 and the processing of step S204 can be performed simultaneously.

Next, in step S206, the CPU 20A inputs the image information B and the driving information B acquired, as is described above, in step S202 and step S204 into the learned model 25 that corresponds to the driver ID acquired in step S200, and determines whether or not the current situation corresponds to a specific situation.

In step S206, if it is determined that the current situation does not correspond to a specific situation (i.e., if the determination result in step S206 is NO), the CPU 20A proceeds to step S218. If, on the other hand, it is determined in step S206 that the current situation does correspond to a specific situation (i.e., if the determination result in step S206 is YES), then the CPU 20A proceeds to step S208.

In step S208, the CPU 20A transmits a switching notification from the notification unit 280 of the vehicle control device 20 to the notification unit 430 of the remote-control controller device 40 notifying it about the switch from remote driving to manual driving.

In step S210, the CPU 20A switches the vehicle 12 from manual driving to remote driving. As a result of this, the vehicle 12 is driven remotely by a remote driver. Note that, in this case, in the vehicle control device 20, operating authority is transferred to the remote driver as a result of the operation switching unit 290 being operated.

In other words, after the operation switching unit 290 of the vehicle control device 20 has been operated, as a result of the operation switching unit 440 of the remote-control controller device 40 then being operated, a switching signal that causes the driving mode to be switched to remote driving is output to the vehicle control device 20. As a result of this, a switch from manual driving to remote driving is made in the vehicle 12.

In step S210, after the vehicle 12 has been switched from manual driving to remote driving, the CPU 20A moves to step S211. In step S211, in the same way as in step S202, the image information B obtained by photographing the external situation around the vehicle 12 is acquired, and in step S212, in the same way as in step S204, the current driving information B is acquired.

In step S213, in the same way as in step S206, the image information B and the driving information B acquired in step S211 and step S212 are input into the learned model 25 that corresponds to the driver ID acquired in step S200, and whether or not the current situation corresponds to a specific situation is determined.

In step S213, if it is determined that the specific situation is continuing (i.e. if the determination result in step S213 is NO), the CPU 20A proceeds to step S211. If, however, it is determined in step S213 that the specific situation has ended (i.e. if the determination result in step S213 is YES), then the CPU 20A proceeds to step S214.

In step S214, the CPU 20A receives the switching notification that was transmitted from the notification unit 430 of the remote-control controller device 40 to the notification unit 280 of the vehicle control device 20 notifying it about the switch from remote driving to manual driving.

In step S216, the CPU 20A switches the vehicle 12 from remote driving to manual driving. As a result of this, the vehicle 12 is driven manually by a driver. Note that, in this case, in the remote-control controller device 40, operating authority is transferred to the driver of the vehicle 12 as a result of the operation switching unit 440 being operated.

In other words, after the operation switching unit 440 of the remote-control controller device 40 has been operated, as a result of the operation switching unit 290 of the vehicle control device 20 then being operated, a switching signal that causes the driving mode to be switched to manual driving is output to the vehicle control device 20. As a result of this, a switch from remote driving to manual driving is made in the vehicle 12.

In step S216, after the vehicle 12 has been switched from remote driving to manual driving by the CPU 20A, the CPU 20A proceeds to step S218.

In step S218, the CPU 20A determines whether or not the vehicle 12 has reached its destination. If it is determined in step S218 that the vehicle 12 has reached its destination (i.e., if the determination result in step S218 is YES), then the flow of switching processing to switch the driving mode in accordance with driver information is ended. Note that if it is determined in step S218 that the vehicle 12 has not reached its destination (i.e., if the determination result in step S218 is NO), then the CPU 20A returns to step S202.

As has been described above, in the present exemplary embodiment, when the determination unit 262 (se FIG. 3) has determined that the current situation is a specific situation, the vehicle 12 is able to be switched from manual driving performed by a driver to remote driving performed by an operator. As a result, the vehicle 12 is able to be driven remotely by a remote driver, and a driver is able to avoid manual driving in specific situations, in other words, in situations in which a driver lacks confidence. To put this another way, because a driver is able to perform manual driving in all situations other than the specific situation, it is no longer necessary for an operator to constantly perform remote driving, so that the operator only need be on standby for when they are required and the load on the operator can be lightened.

Moreover, in the present exemplary embodiment, the image information A showing the peripheral situation around the vehicle 12 and the driving information A which includes data relating to the behavior of the vehicle 12 that have been collected in specific situations when the vehicle 12 is being driven manually are stored in the learning data 23. By then causing a model to be mechanically learned with these different sets of information serving as learning data, a learned model 25 that is associated with a ‘specific situation’ is created using a back-propagation method. In the relevant determination unit 262 it is then determined from the current image information B and the current driving information B that have been collected during the current vehicle trip and input into this learned model 25 whether or not the current situation corresponds to the ‘specific situation’. By employing this method, in the present exemplary embodiment, it is possible to determine with a high degree of accuracy whether the current situation is the particular ‘specific situation’ from the point of view of the driver.

Note that in the present exemplary embodiment, the learned models 25 are created by causing models to be learned mechanically using the image information A showing the peripheral situation around the vehicle 12 and the driving information A that have been collected in specific situations when the vehicle 12 is being driven manually as learning data, however, the method used to create the learned models 25 is not limited to this.

For example, it is also possible for bioinformation (i.e., driving information A) collected when a driver is estimated from the biosensors 34 to be in a state of anxiety to be used as the learning data 23. By estimating that a driver is in a state of anxiety, that driver can be estimated to be in a specific situation. Consequently, as a result of bioinformation being collected as the learning data 23, it is possible for this data to be collected for a so-called ‘specific situation’ even when the driver does not themselves recognize their current situation as being a ‘specific situation’. Because of this, it is possible to determine with an even higher degree of accuracy whether or not the current situation is a particular ‘specific situation’ from the point of view of the driver.

Moreover, in the present exemplary embodiment, it is possible to implement settings that, as a result of the operation switching unit 440 being operated in the remote-control controller device 40, enable a switch to be made from manual driving to remote driving in the vehicle 12. As a consequence, in situations such as if, for example, a remote driver determines from the current traveling state of manual driving being performed by a driver that the vehicle 12 is being driven unsafely, the vehicle 12 can be switched by the remote driver from manual driving to remote driving.

Moreover, in the present exemplary embodiment, as is shown in FIG. 3, the operation switching unit 290 that enables the vehicle 12 to be switched by a driver from manual driving to remote driving is provided in the vehicle control device 20. As a result of a driver operating this operation switching unit 290, it is possible for the driving mode to be switched from manual driving to remote driving in the vehicle 12.

As a consequence, in the present exemplary embodiment, while the vehicle is traveling, a driver is able to switch from manual driving to remote driving not just when a driver is driving in a location where they lack confidence to drive manually, but also if a driver needs to take a break from driving or the like during a trip.

In addition, in the present exemplary embodiment, the notification unit 430 (see FIG. 7) that receives switching notifications for a remote driver when a driver switches from manual driving to remote driving by means of the operation switching unit 290 of the vehicle control device 20 is provided in the remote-control controller device 40 (see FIG. 7).

Accordingly, in the present exemplary embodiment, when the driving mode is switched from manual driving by a driver to remote driving as a result of the operation switching unit 290 being operated, a switching notification transmitted by the notification unit 280 is received by the notification unit 430. As a consequence, in the present exemplary embodiment, a remote driver can be made aware in advance of a forthcoming switch from manual driving to remote driving.

Furthermore, in the present exemplary embodiment, the notification unit 280 that receives the switching notification for a driver when the driving mode is switched via the operation switching unit 440 (see FIG. 7) of the remote-control controller device 40 (see FIG. 7) from manual driving to remote driving is provided in the vehicle control device 20.

Accordingly, in the present exemplary embodiment, when a remote driver switches from manual driving to remote driving via the operation switching unit 440, the switching notification transmitted by the notification unit 430 is received by the notification unit 280. As a consequence, in the present exemplary embodiment, a driver can be made aware in advance of a forthcoming switch from manual driving to remote driving.

Note that in the above-described exemplary embodiment, an example is described in which an automobile is used as the vehicle 12, however, the vehicle of the present disclosure is not limited to being an automobile, and the present disclosure may also be applied to a bus or train.

Note also that, in the above-described exemplary embodiment, it is also possible for the processing executed by the CPU 20A after reading software (i.e., a program), and the processing executed by the CPU 40A after reading software (i.e., a program) to instead be executed by other types of processor than a CPU. Examples of other types of processor include PLD (Programmable Logic Devices) whose circuit structure can be altered after manufacturing such as an FPGA (Field-Programmable Gate Array), and dedicated electrical circuits and the like which are processors having a circuit structure that is designed specifically in order to execute a particular processing such as ASIC (Application Specific Integrated Circuits).

In addition, the processing performed by the CPU 20A and the CPU 40A may be executed by just one type from among these various types of processor, or by a combination of two or more processors that are either the same type or are mutually different types (for example by a plurality of FPGA or by a combination of a CPU and an FPGA). Furthermore, the hardware structure of these different types of processor are, more specifically, electrical circuits obtained by combining circuit elements such as semiconductor elements and the like.

Moreover, in the above-described exemplary embodiment, a mode is described in which a program is stored in advance (i.e., is installed) on a non-temporary recording medium capable of being read by a computer. For example, the execution programs in the vehicle control unit 20 of the vehicle 12 are stored in advance in the ROM 20B.

Moreover, the processing programs in the remote-control controller devices 40 of the remote-control operating devices 16 are stored in advance in the ROM 40B. However, the present disclosure is not limited to this, and it is also possible for each program to be provided by being recorded on a non-temporary recording medium such as a CD-ROM (Compact Disc Read Only Memory), a DVD-ROM (Digital Versatile Disc Read Only Memory), and USB (Universal Serial Bus) memory. Moreover, each program may also be provided by being able to be downloaded from an external device via a network.

The processing flows described in the forgoing exemplary embodiments are also merely examples thereof, and insofar as this does not cause a departure from the spirit or scope of the present disclosure, steps that are not required may be deleted, or new steps added, or the sequence of the steps may be altered.

In addition, the structures of the respective control devices, processing server, and smartphones described in the forgoing exemplary embodiments are also merely examples thereof, and insofar as this does not cause a departure from the spirit or scope of the present disclosure may be altered according to the circumstances.

What is claimed is:

1. A vehicle travel system, comprising:
a determination unit that inputs image information that has been acquired during a current trip of a vehicle, and that shows at least a current peripheral situation around the vehicle, and inputs driving information that shows a state of current manual driving, into a learned model that has been created using image information that has been collected in a specific situation during manual driving for a driver who is manually driving a vehicle that is capable of being switched between manual driving and remote driving, and that shows at least a peripheral situation around the vehicle, and also using driving information that shows the state of the manual driving, the determination unit then determining whether or not the current situation corresponds to the specific situation; and
a switching unit that, when it is determined by the determination unit that the current situation corresponds to the specific situation, is able to switch the manual driving to the remote driving.

2. The vehicle travel system according to claim 1, wherein the driving information showing the state of the manual driving includes behavior information detected by behavior sensors that detect behavior of the vehicle.

3. The vehicle travel system according to claim 1, wherein the driving information showing the state of the manual driving includes bioinformation detected by biosensors that detect a biological state of the driver.

4. The vehicle travel system according to claim 1, further comprising a notification unit that, when the driving mode is switched from manual driving to remote driving by the switching unit, transmits a switching notification to the operator who will perform the remote driving to switch from the manual driving to the remote driving.
